(19) United States
(12) Patent Application Publication
(10) Pub. No.: US 2020/0257029 A1
(43) Pub. Date: Aug. 13, 2020

(54) LIGHT CONVERTING COATING FOR LIGHT DIFFUSING DEVICE

(71) Applicant: Corning Incorporated, Corning, NY (US)

(72) Inventors: Edward John Fewkes, Corning, NY (US); Trista Nicole Hesch, Campbell, NY (US); Stephan Lvovich Logunov, Corning, NY (US); Manuela Ocampo, Corning, NY (US)

(21) Appl. No.: 15/776,199

(22) PCT Filed: Nov. 18, 2016
(86) PCT No.: PCT/US2016/062721

§ 371 Date: May 15, 2018

Related U.S. Application Data
(60) Provisional application No. 62/257,913, filed on Nov. 20, 2015.
(60) Provisional application No. 62/303,032, filed on Mar. 3, 2016.

(51) Int. Cl. F21V 8/00

(52) U.S. Cl. CPC G02B 6/001; G02B 6/0003

(57) ABSTRACT

A light diffusing device is provided. The light diffusing device includes a light diffusing element and an outer polymer coating layer surrounding the light diffusing element, the outer polymer coating layer being the cured product of a liquid polymer blend including a scattering composition and a luminophore.

### CROSS REFERENCE TO RELATED APPLICATIONS

This application claims the benefit of priority of U.S. Provisional Application Ser. No. 62/257,913 filed on Nov. 20, 2015 and U.S. Provisional Application Ser. No. 62/303,032 filed on Mar. 3, 2016, the content of which is relied upon and incorporated herein by reference in its entirety

### FIELD

The present disclosure relates generally to light diffusing devices for use in illumination applications, and, more particularly, to light diffusing devices having color converting coatings.

### BACKGROUND

Light diffusing devices are available which direct light from a light source and distribute the light for area illumination. Light diffusing devices that emit light outward along their length, thereby illuminating the device, are particularly useful for a wide array of applications, such as special lighting, photochemistry, and for use in electronics and display devices. Such light diffusing devices have been used to successfully demonstrate the emission of light of various colors. Light sources capable of emitting electromagnetic radiation that is in the visible light range of wavelengths may be coupled to a light diffusing device to introduce light having different colors into the light diffusing device. Such colored light is then emitted outward from the sides or edges of the light diffusing device. However, light sources capable of emitting light of certain colors can be expensive and can make their use cost prohibitive in many light diffusing device applications.

As an alternative, a luminophore (an atom or chemical compound that manifests luminescence, and includes a variety of fluorophores and phosphors) may be disposed on a surface of the light diffusing device. Often, a coating layer including the luminophore is disposed on a surface of the light diffusing device surrounding one more other coating layers. Electromagnetic radiation emitted from a light source at a first wavelength may interact with the luminophore and be converted to a second wavelength in the visible light range of wavelengths. Similar to the previous discussion, the light source may be chosen based on the wavelength of the light emitted from the light source. Additionally, the luminophore may be chosen based on the intended wavelength of the light emitted from the light diffusing device. In this manner, light having a predetermined color may be emitted from the light diffusing device. However, luminophore materials used for this purpose can be difficult to mix with coating polymers in high concentrations. As a result, it is conventionally necessary for the coating having the luminophore materials to be thick enough to enable adequate light conversion. Where the light diffusing device is an optical fiber, for example, the fiber may have an outer diameter of about 250 μm, and the thickness added by a coating including a luminophore may increase the outer diameter of the fiber to about 500 μm or greater. Such luminophore materials are conventionally expensive and forming coatings thick enough to enable adequate light conversion can be cost prohibitive in light diffusing device applications where low costs are expected.

### SUMMARY

According to an embodiment of the present disclosure, a light diffusing device is provided. The light diffusing device includes a light diffusing element and an outer polymer coating layer surrounding the light diffusing element, the outer polymer coating layer being the cured product of a liquid polymer blend comprising a scattering composition and a luminophore.

According to another embodiment of the present disclosure, a method for forming a light diffusing device is provided. The method includes coating a light diffusing element with a liquid polymer blend comprising a scattering composition and a luminophore, and curing the liquid polymer blend to form an outer polymer coating layer.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The disclosure will be understood more clearly from the following description and from the accompanying figures, given purely by way of non-limiting example, in which:

FIG. 1 illustrates a coated light diffusing device in accordance with the present disclosure.

FIG. 2 illustrates a cross section of a conventional LDF;

FIG. 3 illustrates a cross section of an LDF in accordance with the present disclosure;

FIG. 4 illustrates a parallel section of an LDF in accordance with the present disclosure;

FIG. 5 is a graph showing the relationship of the improvement ratio of the path length of an excitation photon in a phosphor coating layer to the concentration of scattering material in light diffusing fibers according to embodiments of the present disclosure;

FIG. 6 is a graph showing the relationship of the ratio of change in the x chromaticity of CIE 1931 color space value/change in the y chromaticity of CIE 1931 color space value of the color of light emitted from the light diffusing fibers to the concentration of scattering material (wt. %) in the outermost coating layer; and

FIG. 7 is a graph showing the relationship of luminophore concentration in a luminophore-containing coating layer and the outer diameter of the cladding layer in two light diffusing fibers.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

Embodiments of the present disclosure relate generally to light diffusing devices having color converting coatings. FIG. 1 illustrates a coated light diffusing device 200 in accordance with the present disclosure. As used herein, a light diffusing device emits light, usually provided from a light source, outward from the device to thereby illuminate the device. As shown, the coated light diffusing device 200 includes a light diffusing element 220 and an outer polymer coating layer 130 (described in more detail below) which surrounds at least a portion of the light diffusing element 220. For purposes of clarity and consistency, certain exemplary embodiments of the present disclosure will be described below wherein the light diffusing element is a light diffusing fiber. However, it should be understood that additional light diffusing elements are contemplated. For example, the light diffusing element 220 may be an LED, such as is illustrated in FIG. 1, electroluminescence wire, light diffusing or side-emitting optical fiber having various characteristics, or any other device that emits light outward from the device to thereby illuminate the device.

Side-emitting optical fiber may include a plastic or a glass core and a cladding surrounding and in direct contact with the core, where the cladding formed from a material having a lower refractive index than the material of the core. For example, the fiber may include a core formed from Poly(methyl methacrylate) (PMMA) and a cladding formed from fluorinated polymers. Similarly, the fiber may include a glass core and a cladding formed from fluorinated polymers. The fiber may also include a glass core and glass cladding where the refractive index of at least one of the core glass and the cladding glass is modified so that the cladding has a lower refractive index than the core. Side-emitting optical fiber also includes scattering defects. The core region may be doped with small refractive and/or reflective light-scattering particles during manufacture. Alternatively, the surface of the core may be modified or treated to have surface features (“defects”) that scatter light out of the core. Some examples of light-emitting surface defects include serrations, notches, scratches, texture, roughness, corrugations, etching, abrasion, etc. The entire length of fiber can be modified or treated to have side-emitting properties, or just a portion of the fiber, for example, a portion along the length or circumference of the fiber, or both.

As mentioned above, for purposes of clarity and consistency, certain exemplary embodiments of the present disclosure will be described below wherein the light diffusing element is a light diffusing fiber. As used herein, the term “light diffusing fiber” (LDF) refers to a flexible optical waveguide, such as an optical fiber, employing nano-sized structures that are utilized to scatter or diffuse light out of the sides of the fiber, such that light is guided away from the core of the waveguide and through the outer surfaces of the waveguide to provide illumination. Concepts relevant to the underlying principles of the claimed subject matter are disclosed in U.S. Patent Application Publication No. US 2011/0122646 A1, which is incorporated in its entirety herein by reference.

As used herein, the term “nano-structured fiber region” describes a region or area of a fiber with a large number of gas filled voids, or other nano-sized structures. The region or area may have, for example, more than 50 voids, or more than 100 voids, or even more than 200 voids in the cross-section of the fiber. The gas filled voids may contain, for example, SO₂, Kr, Ar, CO₂, N₂, O₂, or mixture thereof. The cross-sectional size (e.g., diameter) of nano-sized structures (e.g., voids) as described herein may vary from about 10 nm to about 1.0 μm (for example, from about 50 nm to about 500 nm), and the length may vary from about 1.0 millimeter to about 50 meters (for example, from about 2.0 mm to about 5.0 meters, or from about 5.0 mm to about 1.0 meter).

LDF as described has good angular scattering properties (uniform dissipation of light away from the axis of the fiber) and good bending performance to avoid bright spots at fiber bends. A desirable attribute of at least some of the embodiments described herein is uniform and high illumination along the length of the fiber. Because the optical fiber is flexible, it allows a wide variety of the shapes to be deployed. The LDF described herein may have no bright spots (due to elevated bend losses) at the bending points of the fiber, such that the illumination provided by the fiber does not vary by more than about 40%. The variation of the illumination provided by the fiber may be less than about 30%, or less than about 20% or even less than about 10%. For example, in at least some embodiments, the average scattering loss of the fiber is greater than about 50 dB/km, and the scattering loss does not vary by more than about 40% (i.e., the scattering loss is within ±40% of the average scattering loss) over any given fiber segment having a length of about 0.2 meters. The average scattering loss of the fiber may be greater than about 50 dB/km with the scattering loss varying by less than about 40% over fiber segments having a length of less than about 0.05 meters. The average scattering loss of the fiber may be greater than about 50 dB/km with the scattering loss varying by less than about 40% over fiber segments having a length of about 0.01 meters. The average scattering loss of the fiber may also be greater than about 50 dB/km with the scattering loss varying by less than about 30%, or less than 20%, or even less than about 10%, over fiber segments having a length of about 0.01 meters.

According to embodiments of the present disclosure, the intensity variation of the integrated light intensity diffused through sides of the fiber at the illumination wavelength is less than about 40% for the target length of the fiber, which can be, for example, between about 0.02 meters to about 100 meters. The light diffusing fiber described herein may produce uniform illumination along the entire length of the fiber or uniform illumination along a segment of the fiber which is less than the entire length of the fiber. As used herein, the term “uniform illumination,” means that the intensity of light emitted from the light diffusing fiber does not vary by more than 25% over the specified length.

LDF designs described herein include a nano-structured fiber region (region with nano-sized structures) placed in the core area of the fiber, or very close to the core. The LDF have scattering losses in excess of about 50 dB/km, for example, greater than about 100 dB/km, greater than about 200 dB/km, greater than about 300 dB/km, greater than about 325 dB/km, greater than about 500 dB/km, greater than about 1000 dB/km, greater than about 3000 dB/km, or even greater than about 5000 dB/km. The scattering loss, and thus illumination, or light radiated by the fiber, is uniform in angular space.

In order to reduce or to eliminate bright spots at bends in the fiber, it is desirable that the increase in attenuation at a 90° bend in the fiber is less than about 5.0 dB/turn, for example, less than about 3.0 dB/turn, less than about 2.0 dB/turn, or even less than about 1.0 dB/turn when the bend diameter is less than about 50 mm. In exemplary embodiments, these low bend losses are achieved at even smaller bend diameters, for example, at bend diameters of less than about 20 mm, less than about 10 mm, or even less than about 5.0 mm. The total increase in attenuation may be less than about 1.0 dB per 90 degree turn at a bend radius of about 5.0 mm.

The bending loss is equal to or is less than the intrinsic scattering loss from the core of the straight fiber. The intrinsic scattering is predominantly due to scattering from the nano-sized structures. Thus, according to at least the bend insensitive embodiments of optical fiber, the bend loss does not exceed the intrinsic scattering of the fiber. However, because scattering level is a function of bending diameter, the bending deployment of the fiber depends on its scattering level. For example, the fiber may have a bend loss of less than about 3.0 dB/turn, or even less than about 2.0 dB/turn, and the fiber can be bent in an arc with a radius as small as about 5.0 mm without forming bright spots.

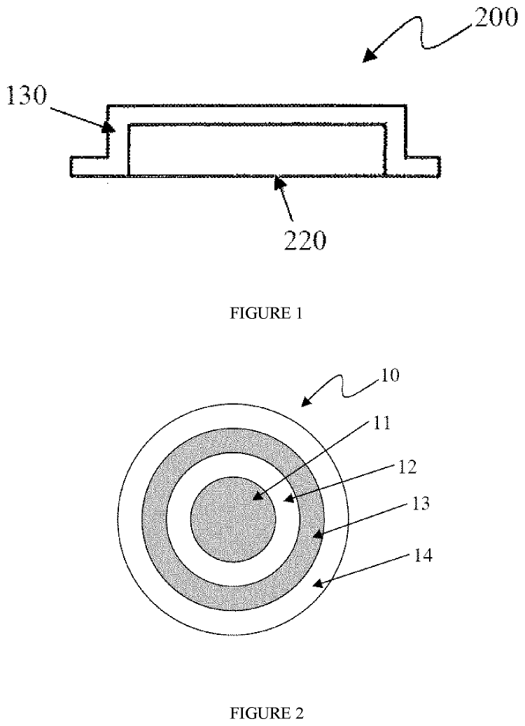

FIG. 2 illustrates an example of a conventional light diffusing fiber and is illustrative of a conventional coated light diffusing device. As shown, the LDF 10 includes a core portion 11 and a cladding 12 which surrounds and is in direct contact with the core portion 11. The LDF 10 also includes a scattering coating layer 13 which surrounds and is in direct contact with the cladding 12 and a separate phosphor coating layer 14 which surrounds the scattering coating layer 13. Because of the separate coating layers, such conventional LDF may have an outer diameter of greater than about 250 μm and commonly has an outer diameter of about 500 μm or greater.

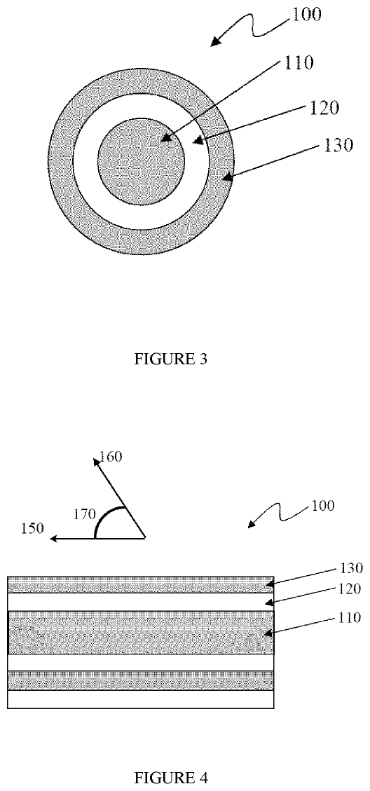

FIG. 3 illustrates an exemplary light diffusing fiber and is illustrative of a coated light diffusing device in accordance with embodiments of the present disclosure. The LDF 100 includes a core portion 110 having an outer radius of greater than about 10 μm and less than about 250 μm, for example, between about 25 μm and about 200 μm, or between about 30 μm and about 100 μm. According to embodiments of the present disclosure, the core portion 110 includes voids that scatter light propagating in the core portion 110 such that the light is directed radially outward from the core portion 110, thereby illuminating the LDF and the space surrounding the LDF. The scatter-induced attenuation may be increased through increasing the concentration of voids, positioning voids throughout the fiber, or in cases where the voids are limited to an annular ring, increasing the width of the void-containing ring will also increase the scattering-induced attenuation for the same density of voids. Additionally, in compositions where the voids are helical, the scattering-induced attenuation may also be increased by varying the pitch of the helical voids over the length of the fiber.

Still referring to FIG. 3, the LDF 100 may further include a cladding 120 which surrounds and is in direct contact with the core portion 110. The cladding 120 may be formed from a material which has a relatively low refractive index in order to increase the numerical aperture (NA) of the LDF 100. The numerical aperture of the fiber may be greater than about 0.3, and in some embodiments greater than about 0.4. The cladding 120 may include a low index polymeric material such as UV or thermally curable fluoroacrylate, such as PC452 available from SSCP Co. Ltd 403-2, Moknae, Ansan, Kyunggi, Korea, or silicone. Such low index polymer cladding may have a relative refractive index that is negative relative to pure undoped silica. For example, the relative refractive index of the low index polymer cladding may be less than about −0.5%, or even less than about −1.0%. Also, the cladding 120 may include a high modulus coating. Alternatively, the cladding 120 may include a silica glass. According to embodiments of the present disclosure, the silica glass in the cladding may be down-doped with a down-dopant, such as, for example, fluorine. As used herein, the term “down-dopant” refers to a dopant which has a propensity to lower the refractive index relative to pure undoped silica. The cladding 120 generally has an index of refraction which is less than the index of refraction of the core portion 110.

The cladding 120 generally extends from the outer radius of the core portion 110. The radial width of the cladding 120 may be greater than about 1.0 μm. For example, the radial width of the cladding 120 may be between about 5.0 μm and about 300 μm, such as less than about 200 μm. The radial width of the cladding 120 may also be, for example, between about 2.0 μm and about 100 μm, between about 2.0 μm and about 50 μm, between at least 2.0 μm and about 20 μm, or even between about 2.0 μm and about 12 μm. The radial width of the cladding 120 may be, for example, at least about 7.0 μm.

Referring again to FIG. 3, the LDF 100 further includes an outer polymer coating layer 130 which surrounds and is in direct contact with the cladding 120. As used herein, the term “outer polymer coating layer” is meant only to relate the position of the polymer coating layer to the light diffusing device and is not meant to designate the polymer coating as being the outermost coating layer of the coated light diffusing device. It should be understood that embodiments of the present disclosure contemplate coated light diffusing devices having one or more additional coatings, for example protective coatings, that surround the outer polymer coating layer 130. The LDF 100 may also include an optional coating between the cladding 120 and the outer polymer coating layer 130. The optional coating is a low modulus material that may be included to better protect the glass portions of the light-diffusing fiber by dissipating mechanical disturbances transmitted through the outer polymer coating layer 130 when the light-diffusing fiber is subjected to an external force. When present, the optional coating surrounds and contacts the cladding 120. In one embodiment, the optional coating is the cured product of a composition that includes a curable crosslinker, a curable diluent, and a polymerization initiator. The composition may include one or more curable crosslinkers, one or more curable diluents, and/or one or more polymerization initiators. In one embodiment, the curable crosslinker is essentially free of urethane and urea functional groups. When present, the optional coating has a lower refractive index than the outer polymer coating.

The outer polymer coating 130 includes a scattering material and a luminophore. The outer polymer coating layer 130 may include a polymer material that may be any liquid polymer or prepolymer material into which a scattering composition (which includes the scattering material) and the luminophore could be added and in which the blend may be applied to the fiber as a liquid and then converted to a solid after application to the fiber. In some embodiments, the outer polymer coating layer 130 is formed from a polymer material such as an acrylate-based polymer or silicone-based polymer.

The scattering composition may be, for example, a dispersion which includes a scattering material and which is added to the liquid polymer blend. The concentration of the scattering composition in the liquid polymer blend of the outer polymer coating may be between about 5.0 wt. % and about 80 wt. %. For example, the concentration of the scattering composition in the liquid polymer blend of the outer polymer coating may be between about 10 wt. % and about 70 wt. %, or between about 20 wt. % and about 60 wt. %, or even between about 30 wt. % and about 60 wt. %.

The scattering material may include nano- or microparticles with an average diameter of from about 200 nm to about 10 μm. For example, the average diameter of the particles may be between about 400 nm and about 8.0 μm, or even between about 100 nm and about 6.0 μm. The nano- or microparticles may be particles of a metal oxide or of other high refractive index materials, such as, but not limited to, TiO₂, ZnO, SiO₂, BaS, MgO, Al₂O₃ or Zr. The scattering material may include TiO₂-based particles, and the scattering composition may be, for example, a white ink dispersion, which provides for an angle independent distribution of light scattered from the core portion 110 of the light diffusing optical fiber 100. The concentration of the particles of the scattering material may vary along the length of the fiber or may be constant and may be a weight percent sufficient to provide even scattering of the light while limiting overall attenuation. The concentration of the particles of the scattering material may be greater than about 0.5 wt. %. For example, the concentration of the particles of the scattering material may be greater than about 1.0 wt. %, or greater than about 1.25 wt. %, or greater than about 1.5 wt. %, or greater than about 2.0 wt. %, or greater than about 2.5 wt. %, or greater than about 3.0 wt. %, or greater than about 3.5 wt. %, or even greater than about 4.0 wt. %. The concentration of the particles of the scattering material may be between about 0.5 wt. % and about 10 wt. %, or between about 1.0 wt. % and about 10 wt. %, or between about 1.25 wt. % and about 7.5 wt. %, or between about 1.25 wt. % and about 6.0 wt. %, or between about 1.5 wt. % and about 10 wt. %, or between about 1.5 wt. % and about 7.5 wt. %, or between about 1.5 wt. % and about 6.0 wt., or between about 2.0 wt. % and about 10 wt. %, or between about 2.0 wt. % and about 7.5 wt. %, or even between about 2.0 wt. % and about 6.0 wt. %. The scattering material may also include nano- or microsized particles or voids of low refractive index, such as gas bubbles.

The luminophore may include a fluorescent or phosphorescent material which may be any organic or inorganic fluorescent or phosphorescent material or a mixture of any organic or inorganic fluorescent or phosphorescent materials. For example, the luminophore may include, but is not limited to, Ce-doped YAG, Nd-doped YAG, rare earth oxide materials, quantum dots such as CdS, CdS/ZnS, InP, nanoparticles, metal-enhanced fluorescence of organic fluorophores, etc. The concentration of luminophore in the liquid polymer blend of the outer polymer coating may be controlled to provide desired color coordinates x and y in CIE color space diagram. The concentration of the luminophore in the liquid polymer blend of the outer polymer coating may be between about 10 wt. % and about 50 wt. %. For example, the concentration of the luminophore in the liquid polymer blend of the outer polymer coating may be between about 15 wt. % and about 45 wt. %, or between about 25 wt. % and about 40 wt. %, or even between about 30 wt. % and about 35 wt. %.

The outer polymer coating layer 130 generally extends from the outer radius of the cladding 120. The radial width of the outer polymer coating layer 130 may be between about 1.0 μm and about 450 μm, for example, between about 20 μm and about 300 μm, or even between about 40 μm and about 90 μm. The radial width of LDF designs according to embodiments of the present disclosure may be limited such that the outer diameter of the LDF is less than or equal to about 500 μm, or less than or equal to about 400 μm, or even less than or equal to about 300 μm.

Because the outer polymer coating layer 130 includes both a scattering material and a luminophore, the outer polymer coating layer 130 enhances the distribution and/or the nature of the light emitted radially from the core portion 110 and converts light emitted radially from the core portion 110 to a longer wavelength of light. The efficiency of the luminophore to convert light is known to be related to luminophore concentration and to the amount of the luminophore-containing material (i.e. thickness or volume of the material). Generally, promotion of an electron to a higher energy level, or excitation, occurs upon absorption of a photon (an “excitation photon”), and adequate light conversion is related to the period of time (i.e.: the number of interactions between the excitation photon and the luminophore) which the excitation photon interacts with the luminophore. As such, the number of interactions between the excitation photons and the luminophore is proportional to the concentration of the luminophore and the thickness of the luminophore-containing material. Typical conversion efficiency for a single interaction is greater than about 90%. Conventionally, to enable adequate light conversion in light diffusing optical fiber, luminophore concentration and/or thickness of luminophore-containing coatings are increased. However, because it can be difficult to mix high luminophore concentrations with coating polymers, enabling adequate light conversion is conventionally achieved by increasing the thickness of luminophore-containing coatings on the fiber. Without wishing to be limited by any particular theory, it is believed that including both a scattering material and a luminophore in the same coating layer increases the path length of the excitation photon independently of coating thickness, which in turn effectively reduces the thickness of the coating layer. LDF having greater than about 0 wt. % scattering material in the outer polymer coating layer 130 displayed a path length of the excitation photon that was greater than the actual thickness of the polymer coating layer 130. In particular, LDF having about 0.50 wt. % or greater of scattering material in the outer polymer coating layer 130 displayed a path length of the excitation photon that was greater than about 2.0 times the actual thickness of the polymer coating 130.

FIG. 4 shows a parallel section of the LDF 100 illustrated in FIG. 3. As shown, unscattered light propagates down the length of LDF 100 from the source in the direction shown by arrow 150. Scattered light, shown by arrow 160, exits LDF 100 at an angle 170, where the angle 170 describes angular difference between the direction of the fiber and the direction of the scattered light when it leaves LDF 100. The UV-visible spectrum of LDF 100 may be independent of angle 170. Alternatively, the intensities of the spectra when angle 170 is between about 20° and about 150° are within ±40% as measured at the peak wavelength. For example, the intensities of the spectra when angle 170 is between about 20° and about 150° may be within ±30%, or ±20%, or ±15%, or ±10%, or even ±5%, as measured at the peak wavelength.

Colored light can be emitted from the LDF 100 having an outer polymer coating layer 130 in accordance with the present disclosure by coupling the LDF 100 with a higher energy (lower wavelength) light source, such as a light source emitting at 405 nm or 445 nm. The light source may be configured to emit light having a wavelength of between about 300 nm and about 550 nm. The light source may be, for example, a diode laser. The light from the light source is emitted from the core portion 110 and causes the luminophore to fluoresce or phosphoresce such that the wavelength of the light emitted from the LDF 100 corresponds to a predetermined color. Where the luminophore includes a mixture of fluorescent or phosphorescent materials, the mixture may be modified and controlled such that the wavelength of the light emitted from the LDF 100 corresponds to a predetermined color.

The fibers described herein may be formed utilizing various techniques. For example, the core 110 can be made by any number of methods which incorporate voids or particles into the glass fiber. For example, methods for forming an optical fiber preform with voids are described in, for example, U.S. Patent Application Publication No. 2007/0104437 A1, which is incorporated in its entirety herein by reference. Additional methods of forming voids may be found in, for example, U.S. Patent Application Publication No. 2011/0122646 A1, U.S. Patent Application Publication No. 2012/0275180 A1, and U.S. Patent Application Publication No. 2013/0088888 A1, which are incorporated in their entirety herein by reference.

According to embodiments of the present disclosure, a method for forming a light diffusing fiber includes forming an optical fiber preform having a preform core portion. The method may further include drawing the optical fiber preform to form an optical fiber and coating the optical fiber with an outer polymer coating layer that includes a scattering material and a luminophore.

The method may further include coating the optical fiber with a polymeric cladding layer that surrounds and is in direct contact with the core. Where the optical fiber is coated with a polymeric cladding layer, coating the optical fiber with the outer polymer coating layer includes coating the cladding layer with the outer polymer coating layer. Alternatively, the optical fiber preform may further include a silica-based glass cladding portion surrounding and in direct contact with the preform core portion. Such optical fiber preform may be drawn to form an optical fiber having a silica-based glass cladding, and coating the optical fiber with the outer polymer coating layer includes coating the silica-based glass cladding with the outer polymer coating layer.

Generally, the optical fiber is drawn from an optical fiber preform with a fiber take-up system and exits the draw furnace along a substantially vertical pathway. The fiber may be rotated as it is drawn to produce helical voids along the long axis of the fiber. As the optical fiber exits the draw furnace, a non-contact flaw detector may be used to examine the optical fiber for damage and/or flaws that may have occurred during the manufacture of the optical fiber. Thereafter, the diameter of the optical fiber may be measured with a non-contact sensor. As the optical fiber is drawn along the vertical pathway, the optical fiber may optionally be drawn through a cooling system which cools the optical fiber prior to the application of coatings to the optical fiber. After the optical fiber exits the draw furnace or optional cooling system, the optical fiber enters at least one coating system where one or more polymer layers are applied to the optical fiber. As the optical fiber exits the coating system, the diameter of the optical fiber may be measured with non-contact sensor. Thereafter, a non-contact flaw detector is used to examine the optical fiber for damage and/or flaws in the coating that may have occurred during the manufacture of the optical fiber.

### Examples

Embodiments of the present disclosure are further described below with respect to certain exemplary and specific embodiments thereof, which are illustrative only and not intended to be limiting.

Table I illustrates characteristics and performance of various outer polymer coating layers in accordance with embodiments of the present disclosure. Light diffusing optical fibers 1-5 included outer polymer coating layers in accordance with the outer polymer coating layer 130 illustrated in FIG. 3. The outer polymer coating layer in each of fibers 1-5 was applied to an LDF that included a core portion, a cladding portion and a coating layer that was the cured product of a polymer material. As a comparison, light diffusing optical fibers 6-8 were conventional LDF including the various glass portions and polymer layers as the LDF illustrated in FIG. 2 with the outermost coating being a phosphor coating layer 14.

For the outermost coating layer of each of the fibers, Table I shows concentration of scattering composition (wt. %), concentration of scattering material (wt. %) and concentration of luminophore (wt. %), in the liquid polymer blend. Table I shows the concentration of polymer material (wt. %) in the scattering composition and also the coating thickness (μm) of the cured coating layer. Table I also shows CIE 1931 x, y chromaticity space values for the color of the light emitted from each of the fibers.

TABLE I

| | Scattering | | | | | | |
|---|---|---|---|---|---|---|---|
| | Composi- | Lumin- | Polymer | Scattering | Thick- | | |
| | tion | ophore | Material | Material | ness | | |
| | (wt. %) | (wt. %) | (wt. %) | (wt. %) | (μm) | x | y |
| 1 | 15 | 28 | 57 | 0.75 | 90 | 0.365 | 0.445 |
| 2 | 15 | 28 | 57 | 0.75 | 140 | 0.39 | 0.49 |
| 3 | 10 | 30 | 60 | 0.50 | 90 | 0.345 | 0.405 |
| 4 | 30 | 23 | 47 | 1.50 | 90 | 0.31 | 0.34 |
| 5 | 40 | 20 | 40 | 2.00 | 50 | 0.28 | 0.25 |
| 6 | 0 | 33 | 67 | 0 | 25 | 0.27 | 0.23 |
| 7 | 0 | 33 | 67 | 0 | 100 | 0.3 | 0.3 |
| 8 | 0 | 33 | 67 | 0 | 190 | 0.36 | 0.41 |

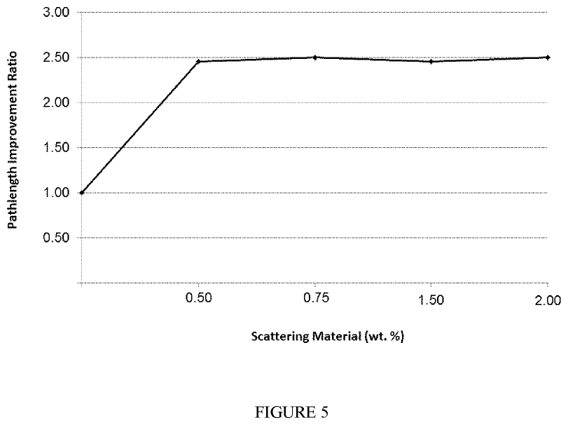

From the data in Table I, the path length of an excitation photon in the outermost coating layer was estimated and compared to the actual thickness of the outermost coating layer. FIG. 5 is a graph showing the relationship of the improvement ratio of the path length of an excitation photon in the outermost coating layer to the concentration of scattering material (wt. %) in coated light diffusing devices according to embodiments of the present disclosure. As shown, where the outermost coating layer has a concentration of scattering material of about 0.50 wt. % or more, the path length of an excitation photon is more than 2.0 times greater than the actual thickness of the outermost coating layer.

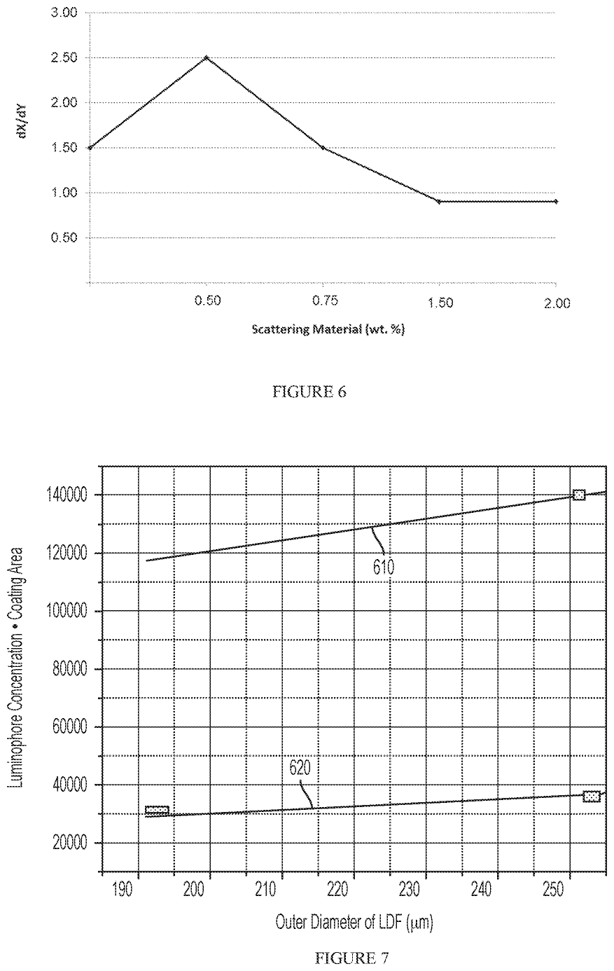

Embodiments of the present disclosure provide light diffusing devices having reduced luminophore concentration in the coatings that emit light having the same color and the same or better uniformity as conventional light diffusing devices. Differences in the CIE 1931 x, y chromaticity space values for the color of the light emitted from light diffusing fibers at different viewing angles was observed and measured. FIG. 6 is a graph showing the relationship of the ratio of change in the x chromaticity of CIE 1931 color space value/change in the y chromaticity of CIE 1931 color space value of the color of light emitted from the light diffusing fibers to the concentration of scattering material (wt. %) in the outermost coating layer. The lower the ratio, the better the uniformity of the color of the emitted light. As shown, where the outermost coating layer has a concentration of scattering material of about 0.50 wt. % or more, the uniformity of the color of light emitted from the light diffusing fibers is the same or better than the conventional LDF having no scattering material in the outermost coating layer.

As less luminophore is needed in the outer polymer coating, the overall costs of the light diffusing device is reduced. FIG. 7 is a graph showing the relationship of luminophore concentration in a luminophore-containing coating layer (illustrated with a value that is the result of luminophore concentration in the coating multiplied by the area of the coating) and the outer diameter of the LDF in two light diffusing fibers 610 and 620. The two fibers 610 and 620 were designed to emit light having a color that can be defined as 0.31:0.31 using CIE 1931 x, y chromaticity space values. Fibers 610 were conventional LDF, such as is illustrated in FIG. 2, having a phosphor coating layer 14 having a thickness of 120 μm. Fibers 620 were formed in accordance with the LDF illustrated in FIG. 3 and had an outer polymer coating layer 130 having a thickness of 40 μm. As is shown, for all cladding outer diameters between 190 μm and 260 μm, fibers 620 emitted light having the same color as fibers 610 with a reduced luminophore concentration. In particular, luminophore concentration of fibers 620 was between about 3.5 and about 5.0 times less than luminophore concentration of fibers 610.

According to an aspect (1) of the present disclosure, a light diffusing device is provided. The light diffusing device comprises a light diffusing element, and an outer polymer coating layer surrounding the light diffusing element, the outer polymer coating layer being the cured product of a liquid polymer blend comprising a scattering composition and a luminophore.

According to an aspect (2) of the present disclosure, the light diffusing device of aspect (1) is provided, wherein the outer polymer coating layer comprises a radial width of between about 1.0 μm and about 450 μm.

According to an aspect (3) of the present disclosure, the light diffusing device of any of the aspects (1)-(2) is provided, wherein the scattering composition comprises high refractive index materials.

According to an aspect (4) of the present disclosure, the light diffusing device of aspect (3) is provided, wherein the high refractive index materials comprise metal oxide particles.

According to an aspect (5) of the present disclosure, the light diffusing device of aspect (4) is provided, wherein the metal oxide particles are selected from the group consisting of particles of TiO₂, ZnO, SiO₂, BaS, MgO, Al₂O₃ and Zr.

According to an aspect (6) of the present disclosure, the light diffusing device of aspect (5) is provided, wherein the metal oxide particles comprise particles of TiO₂.

According to an aspect (7) of the present disclosure, the light diffusing device of aspect (6) is provided, wherein the scattering composition comprises a white ink dispersion.

According to an aspect (8) of the present disclosure, the light diffusing device of any of aspects (1)-(7) is provided, wherein the liquid polymer blend comprises greater than about 0.5 wt. % of the scattering material.

According to an aspect (9) of the present disclosure, the light diffusing device of any of aspects (1)-(8) is provided, wherein the liquid polymer blend comprises between about 0.5 wt. % and about 10 wt. % of the scattering material.

According to an aspect (10) of the present disclosure, the light diffusing device of any of aspects (1)-(9) is provided, wherein the luminophore is selected from the group consisting of a fluorescent material, a phosphorescent material, and mixtures thereof

According to an aspect (11) of the present disclosure, the light diffusing device of any of aspects (1)-(10) is provided, wherein the luminophore is selected from the group consisting of Ce-doped YAG, Nd-doped YAG, rare earth oxide materials, quantum dots, nanoparticles, and metal-enhanced fluorescence of organic fluorophores.

According to an aspect (12) of the present disclosure, the light diffusing device of any of aspects (1)-(11) is provided, wherein the liquid polymer blend comprises between about 10 wt. % and about 50 wt. % of the luminophore.

According to an aspect (13) of the present disclosure, the light diffusing device of any of aspects (1)-(12) is provided, wherein the light diffusing element is a light diffusing fiber comprising: a core formed from a silica-based glass; and a cladding in direct contact with the core.

According to an aspect (14) of the present disclosure, the light diffusing device of aspect (13) is provided, wherein the light diffusing fiber comprises an outer diameter of less than or equal to about 250 μm.

According to an aspect (15) of the present disclosure, the light diffusing device of any of aspects (13)-(14) is provided, wherein the core comprises nano-sized structures.

According to an aspect (16) of the present disclosure, the light diffusing device of aspect (15) is provided, wherein the nano-sized structures comprise gas-filled voids.

According to an aspect (17) of the present disclosure, the light diffusing device of aspect (16) is provided, wherein the gas-filled voids are filled with a gas selected from the group of SO₂, Kr, Ar, CO₂, N₂, O₂ and mixtures thereof.

According to an aspect (18) of the present disclosure, the light diffusing device of any of aspects (15)-(17) is provided, wherein the nano-sized structures have a diameter of about 10 nm to about 1.0 μm.

According to an aspect (19) of the present disclosure, the light diffusing device of any of aspects (13)-(18) is provided, where the light diffusing fiber comprises uniform illumination over any given fiber segment having a length of about 0.2 meters.

According to an aspect (20) of the present disclosure, the light diffusing device of any of aspects (13)-(19) is provided, wherein illumination varies by less than about 40% over any given fiber segment having a length of about 0.2 meters.

According to an aspect (21) of the present disclosure, the light diffusing device of any of aspects (13)-(20) is provided, where the light diffusing fiber comprises uniform illumination over the entire length of the fiber.

According to an aspect (22) of the present disclosure, the light diffusing device of any of aspects (13)-(21) is provided, where the light diffusing fiber comprises an average scattering loss of greater than about 50 dB/km.

According to an aspect (23) of the present disclosure, a method for forming a light diffusing device is provided. The method comprises: coating a light diffusing element with a liquid polymer blend comprising a scattering composition and a luminophore; and curing the liquid polymer blend to form an outer polymer coating layer.

According to an aspect (24) of the present disclosure, the method of aspect (23) is provided, wherein the scattering material comprises high refractive index materials.

According to an aspect (25) of the present disclosure, the method of aspect (24) is provided, wherein the high refractive index materials comprise metal oxide particles.

According to an aspect (26) of the present disclosure, the method of aspect (25) is provided, wherein the metal oxide particles are selected from the group consisting of particles of TiO₂, ZnO, SiO₂, BaS, MgO, Al₂O₃ and Zr.

According to an aspect (27) of the present disclosure, the method of aspect (26) is provided, wherein the metal oxide particles comprise particles of TiO₂.

According to an aspect (28) of the present disclosure, the method of aspect (27) is provided wherein the scattering composition comprises a white ink dispersion.

According to an aspect (29) of the present disclosure, the method of any of aspects (23)-(28) is provided, wherein coating the optical fiber comprises coating the optical fiber with a liquid polymer blend comprising greater than about 0.5 wt. % of the scattering material.

According to an aspect (30) of the present disclosure, the method of any of aspects (23)-(29) is provided, wherein coating the optical fiber comprises coating the optical fiber with a liquid polymer blend comprising between about 1.0 wt. % and about 10 wt. % of the scattering material.

According to an aspect (31) of the present disclosure, the method of any of aspects (23)-(30) is provided, wherein the luminophore is selected from the group consisting of a fluorescent material, a phosphorescent material, and mixtures thereof

According to an aspect (32) of the present disclosure, the method of any of aspects (23)-(31) is provided, wherein the luminophore is selected from the group consisting of Ce-doped YAG, Nd-doped YAG, rare earth oxide materials, quantum dots, nanoparticles, and metal-enhanced fluorescence of organic fluorophores.

According to an aspect (33) of the present disclosure, the method of any of aspects (23)-(32) is provided, wherein coating the optical fiber comprises coating the optical fiber with a liquid polymer blend comprising between about 10 wt. % and about 50 wt. % of the luminophore.

According to an aspect (34) of the present disclosure, the method of any of aspects (23)-(33) is provided, wherein the light diffusing element comprises a light diffusing optical fiber, and wherein the method further comprises: forming an optical fiber preform having a silica-based glass preform core; and drawing the optical fiber preform to form an optical fiber.

According to an aspect (35) of the present disclosure, the method of aspect (34) is provided, wherein the optical fiber preform further comprises a cladding comprising silica glass, and wherein coating the optical fiber with the outer polymer coating layer comprises coating the cladding with the outer polymer coating layer.

According to an aspect (36) of the present disclosure, the method of aspect (34) is provided further comprising coating the optical fiber with a polymeric cladding layer, wherein coating the optical fiber with the outer polymer coating layer comprises coating the polymeric cladding layer with the outer polymer coating layer.

According to an aspect (37) of the present disclosure, the method of aspect (34) is provided, wherein drawing the optical fiber preform comprises forming an optical fiber having a silica-based glass preform core comprising nano-sized structures.

According to an aspect (38) of the present disclosure, the method of aspect (37) is provided, wherein the nano-sized structures comprise gas-filled voids.

According to an aspect (39) of the present disclosure, the method of aspect (38) is provided, wherein the gas-filled voids are filled with a gas selected from the group of SO₂, Kr, Ar, CO₂, N₂, O₂ and mixture thereof.

According to an aspect (40) of the present disclosure, the method of any of aspects (37)-(39) is provided, wherein the nano-sized structures have a diameter of about 10 nm to about 1.0 μm.

It will be apparent to those skilled in the art that various modifications and variations can be made without departing from the spirit or scope of the present disclosure.

1. A light diffusing device comprising;
a light diffusing element; and
an outer polymer coating layer surrounding the light diffusing element, the outer polymer coating layer being the cured product of a liquid polymer blend comprising a scattering composition and a luminophore.

2. The light diffusing device of claim 1, wherein the outer polymer coating layer comprises a radial width of between about 1.0 μm and about 450 μm.

3. The light diffusing device of any of the preceding claims claim 1, wherein the scattering composition comprises high refractive index materials.

4. The light diffusing device of claim 3, wherein the high refractive index materials comprise metal oxide particles.

5. The light diffusing device of claim 4, wherein the metal oxide particles are selected from the group consisting of particles of TiO₂, ZnO, SiO₂, BaS, MgO, Al₂O₃ and Zr.

6.-9. (canceled)

10. The light diffusing device of claim 1, wherein the luminophore is selected from the group consisting of a fluorescent material, a phosphorescent material, and mixtures thereof.

11. (canceled)

12. (canceled)

13. The light diffusing device of claim 1, wherein the light diffusing element is a light diffusing fiber comprising:
a core formed from a silica-based glass; and
a cladding in direct contact with the core.

14. The light diffusing device of claim 13, wherein the light diffusing fiber comprises an outer diameter of less than or equal to about 250 μm.

15. The light diffusing device of claim 13, wherein the core comprises nano-sized structures.

16. The light diffusing device of claim 15, wherein the nano-sized structures comprise gas-filled voids.

17.-22. (canceled)

23. A method for forming a light diffusing device, the method comprising:
coating a light diffusing element with a liquid polymer blend comprising a scattering composition and a luminophore; and
curing the liquid polymer blend to form an outer polymer coating layer.

24. The method of claim 23, wherein the scattering material comprises high refractive index materials.

25. The method of claim 24, wherein the high refractive index materials comprise metal oxide particles.

26.-30. (canceled)

31. The method of claim 23, wherein the luminophore is selected from the group consisting of a fluorescent material, a phosphorescent material, and mixtures thereof.

32. The method of claim 23, wherein the luminophore is selected from the group consisting of Ce-doped YAG, Nd-doped YAG, rare earth oxide materials, quantum dots, nanoparticles, and metal-enhanced fluorescence of organic fluorophores.

33. The method of claim 23, wherein coating the optical fiber comprises coating the optical fiber with a liquid polymer blend comprising between about 10 wt. % and about 50 wt. % of the luminophore.

34. The method of claim 23, wherein the light diffusing element comprises a light diffusing optical fiber, and wherein the method further comprises:
forming an optical fiber preform having a silica-based glass preform core; and
drawing the optical fiber preform to form an optical fiber.

35. (canceled)

36. (canceled)

37. The method of claim 34, wherein drawing the optical fiber preform comprises forming an optical fiber having a silica-based glass preform core comprising nano-sized structures.

38. The method of claim 37, wherein the nano-sized structures comprise gas-filled voids.

39. (canceled)

40. The method of claim 37, wherein the nano-sized structures have a diameter of about 10 nm to about 1.0 μm.
